(19) United States
(12) Patent Application Publication
(10) Pub. No.: US 2002/0164140 A1
(43) Pub. Date: Nov. 7, 2002

(54) Few-mode fiber profile

(76) Inventors: Michael Lysiansky, Ramat Gan (IL); David Menashe, Kiryat Ono (IL); Yochay Danziger, Dallas, TX (US)

Correspondence Address: LASERCOMM, INC., INTELLECTUAL PROPERTY DEPT., 2600 TECHNOLOGY DRIVE SUITE 900, PLANO, TX, 75074, US

(21) Appl. No.: 10/135,449

(22) Filed: May 1, 2002

Related U.S. Application Data
(63) Continuation-in-part of application No. 09/481,428, filed on Jan. 12, 2000.

(51) Int. Cl. G02B 6/22; G02B 6/16

(52) U.S. Cl. 385/127; 385/123

(57) ABSTRACT

A family of fiber profiles is disclosed which exhibit only three well guided modes in the operative “band”. The reduction in the number of modes is accomplished with a change in the refractive index in the core area. The change in refractive index in the core area changes the order of the appearance of the modes, thus leading to fewer guided modes, and less MPI. In one embodiment the refractive index ring comprises an area of depressed refractive index, and the null energy point of one of the guided modes is found therein. In another embodiment, the change in the refractive index in the core is located coincidentally with the null point of a desired mode. In some embodiments negative dispersion on the order of −400 ps/nm/km is experienced, while MPI is minimized. In another embodiment the fiber profile is further characterized by a negative slope suitable for compensating a link of transmission fiber.

### CROSS-REFERENCE TO RELATED APPLICATIONS

This application is a continuation-in-part application of U.S. patent application Ser. No. 09/481,428 filed Jan. 12, 2000 entitled “REDUCING MODE INTERFERENCE IN TRANSMISSION OF A HIGH ORDER MODE IN OPTICAL FIBERS”, and incorporates by reference U.S. patent application Ser. No. 09/248,969 filed Feb. 12, 1999 entitled “TRANSVERSE SPATIAL MODE TRANSFORMER FOR OPTICAL COMMUNICATION” and U.S. patent application Ser. No. 09/510,027 filed Feb. 22, 2000, entitled “HIGH ORDER SPATIAL MODE OPTICAL FIBER”.

### BACKGROUND OF THE INVENTION

Optical fiber has become increasingly important in many applications involving the transmission of light. When a pulse of light is transmitted through an optical fiber, the energy follows a number of paths which cross the fiber axis at different angles. A group of paths which cross the axis at the same angle is known as a mode. The fundamental mode, also known as the LP₀₁ mode, is the mode in which light passes substantially along the fiber axis. Modes other than the LP₀₁ mode, are known as high order modes. Fibers which have been designed to support only one mode with minimal loss, the LP₀₁ mode, are known as single mode fibers. A multi-mode fiber is a fiber whose design supports multiple modes, and typically supports over 100 modes. A few-mode fiber is a fiber designed to support only a very limited number of modes. For the purpose of this patent, we will define a few mode fiber as a fiber supporting no more than 20 modes at the operating wavelength. Fibers may carry different numbers of modes at different wavelengths, however in telecommunications the typical wavelengths are near 1310 nm and 1550 nm.

Light in each mode travels at its own velocity, and thus light traveling in different modes may interfere with each other at the detector. This is known as multi-path interference or MPI. As the number of modes supported by the waveguide increases, the ability to minimize MPI is reduced. Furthermore, optical energy traveling in one mode may couple to a second mode whose propagation constant is nearly the same. The amount of leakage is dependent on the difference in the propagation constant between the modes. The propagation constant of a mode in a fiber is also known as the β of the mode, and the difference between the propagation coefficients of two modes is known as the δβ of the modes. The propagation constant β is related to the effective refractive index of the mode n_{eff} by the formula

$$β = \frac{2 π * {n}_{eff}}{λ}$$

where λ is the wavelength of interest, and n_{eff} is the effective refractive index of the mode. Guided modes are defined as those whose n_{eff} are between the refractive index, n, of the core and that of the cladding. The closer the n_{eff} of the mode is to the n of the cladding, the more weakly guided is the mode.

The core of the fiber may be made up of different regions, each with its own characteristic refractive index. A particular region begins at the point where the refractive index characteristic of that region begins, and a particular region ends at the last point where the refractive index is characteristic of that particular region. In general, we will use the point of return to the refractive index of the cladding to define the border between two adjacent regions that cross the cladding index. Radius will have this definition unless otherwise noted in the text.

As light traverses the optical fiber, different groups of wavelengths travel at different speeds depending on their wavelength, which leads to chromatic dispersion. Chromatic dispersion is defined as the differential of the group velocity in relation to the wavelength in units of picosecond/nanometer (ps/nm). In optical fibers the dispersion experienced by each wavelength of light is also different, and is primarily controlled by a combination of the material dispersion, and the dispersion created by the actual profile of the waveguide, known as waveguide dispersion. Total dispersion is defined as the algebraic sum of waveguide dispersion and material dispersion. Total dispersion in this patent refers to chromatic dispersion. The units of total dispersion are in ps/nm, and a waveguide fiber may be characterized by the amount of dispersion per unit length, in units of ps/nm/km.

The differential of the dispersion in relation to wavelength is known as the slope, or second order dispersion, and is expressed in units of ps/nm². Optical fibers may be further characterized by their slope per unit length of 1 kilometer, which is expressed in units of picosecond/nanometer²/kilometer (ps/nm²/km).

Few mode fibers designed to have specific characteristics in a mode other than the fundamental mode are also known as high order mode (HOM) fibers. HOM fibers are particularly useful for compensating chromatic dispersion due to the large amount of negative dispersion which can be experienced by a signal traversing certain profiles in a high order mode. Additionally, HOM fibers may compensate for much or all of the slope of a given transmission fiber.

Fiber profiles designed to support a specific high order mode exist. U.S. Pat. No. 5,802,234 discloses an HOM fiber with a refractive index profile selected such that the fiber supports the LP₀₁ and LP₀₂ modes, and typically one or more further higher order modes, and the dispersion is substantially all in the LP₀₂ mode. However, the existence of the further high order modes leads to MPI. The profile shown supports approximately 8 modes over the C band.

U.S. Pat. No. 6,327,403 discloses a method of minimizing MPI by use of an absorbing annulus placed so as to affect the desired LP₀₂ mode to a lesser degree than all other undesired modes. The use of an absorbing annulus requires an extra step in the production process, and utilizes absorbing materials not commonly used in transmission fiber production.

There is therefore a need for an improved few mode fiber profile for an HOM fiber which exhibits reduced MPI.

### DEFINITIONS

Refractive index profile describes the variation of glass refractive index along a waveguide fiber radius. Δ(r) is expressed both in absolute differential from the cladding Δ(r)=n(r)−n₀ and in percentage terms defined as Δ(r)=100*(n(r)−n₀)/n₀, where n₀ is the refractive index of pure vitreous SiO₂.

The radii of the regions of the core are defined in terms of the index of refraction. A particular region begins at the point where the refractive index characteristic of that region begins, and a particular region ends at the last point where the refractive index is characteristic of that particular region. In general, whenever relevant we will use the point of return to the refractive index of the cladding to define the border between two adjacent regions that cross the cladding index. Radius will have this definition unless otherwise noted in the text.

Projected zero dispersion (PZD) is defined as

$${λ}_{0} - \frac{D ( {λ}_{0} )}{Slope ( {λ}_{0} )} .$$

Typically λ₀ is chosen as 1550 nm, and the slope of the dispersion characteristic at that wavelength is used. A dispersion compensating fiber should ideally have the same PZD as the transmission fiber which it compensates. For a fiber having a non-linear dispersion characteristic over the operative range, a best fit line of the dispersion characteristic is utilized so as to minimize any residual dispersion.

### SUMMARY OF THE INVENTION

Accordingly, it is a principal object of the present invention to overcome the disadvantages of the prior art in the design of a few mode optical waveguide such as an optical fiber with reduced MPI. This is provided in the present invention by providing a few mode fiber profile exhibiting no more than three modes which are well guided and exhibit a small bending loss for a radius of approximately 4 cm. The bending loss is substantially less than 1 db/cm, preferably less than 10⁻⁶ db/cm. In a preferred embodiment one of the three modes is the LP₀₂ mode, and in another preferred embodiment one of the three modes is the LP₁₁ mode. In a preferred embodiment the refractive index profile comprises a first core area of increased refractive index, comprising a depressed refractive index ring, an adjacent second core area with depressed refractive index and an adjacent third core area with increased refractive index. Preferably the depressed refractive index ring is located at the null energy point of the LP₀₂ mode. In a preferred embodiment the optical waveguide exhibits negative dispersion for one of the desired modes, and preferably also negative dispersion slope.

In another embodiment the invention provides for a few mode optical waveguide having a refractive index profile preselected to support no more than three modes at an operating wavelength, with the refractive index profile comprising a refractive index step placed substantially at a location where one of the desired modes has substantially zero energy. Preferably the LP₀₂ mode is chosen as the desired mode which has substantially zero energy. In a preferred embodiment one of the desired modes is the LP₀₂ mode, and in another preferred embodiment one of the desired modes is the LP₁₁mode. In one embodiment the refractive index step comprises a reduction in the refractive index in the core area, while in another embodiment the refractive index step comprises an increase in the refractive index in the core area.

In a preferred embodiment the refractive index profile comprises a first core region of increased refractive index, a second core region of lower increased refractive index, a third core region of depressed refractive index and fourth core region of increased refractive index. In a preferred embodiment the waveguide exhibits negative dispersion for an optical signal in one of the desired modes, preferably also negative dispersion slope.

Additional features and advantages of the invention will become apparent from the following drawings and description.

### BRIEF DESCRIPTION OF THE DRAWINGS

The above and further advantages of this invention may be better understood by referring to the following description taken in conjunction with the accompanying drawings in which like numerals designate corresponding elements or sections throughout, and in which:

FIG. 1 illustrates a radial view of a refractive index profile according to a first embodiment of the invention;

FIG. 2 illustrates the mode intensity of the LP₀₂ mode as a function of the radius for the profile of FIG. 1;

FIG. 3 illustrates the dispersion of a fiber according to the profile of FIG. 1 as a function of wavelength;

FIG. 4 illustrates a radial view of a refractive index profile for comparison with the profile of FIG. 1;

FIG. 5 illustrates the mode intensity of the LP₀₂ mode as a function of the radius for the profile of FIG. 4;

FIG. 6 illustrates the dispersion of a fiber according to the profile of FIG. 4 as a function of wavelength;

FIG. 7 illustrates a radial view of a refractive index profile according to a second embodiment of the invention;

FIG. 8 illustrates the mode intensity of the LP₀₂ mode as a function of the radius for the profile of FIG. 7;

FIG. 9 illustrates the dispersion of a fiber according to the profile of FIG. 7 as a function of wavelength;

FIG. 10 illustrates a radial view of a refractive index profile according to a third embodiment of the invention;

FIG. 11 illustrates the mode intensity of the LP₀₂ mode as a function of the radius for the profile of FIG. 10;

FIG. 12 illustrates the dispersion of a fiber according to the profile of FIG. 10 as a function of wavelength;

FIG. 13 illustrates a radial view of a refractive index profile for comparison with the profile of FIG. 10;

FIG. 14 illustrates the mode intensity of the LP₀₂ mode as a function of the radius for the profile of FIG. 13;

FIG. 15 illustrates the dispersion of a fiber according to the profile of FIG. 13 as a function of wavelength, and FIG. 16 illustrates a high level block diagram of a system utilizing the fiber according to the teaching of the invention.

### DETAILED DESCRIPTION

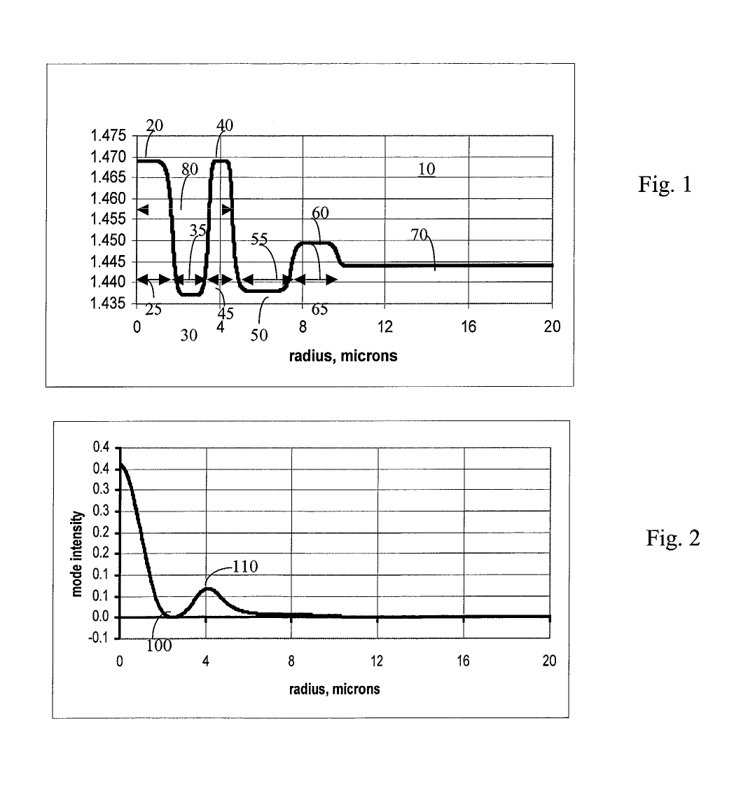

FIG. 1 illustrates a profile 10 of a few mode fiber designed to have strongly negative dispersion in the “C” band of 1520 nm-1565 nm in accordance with the subject invention. The x-axis of FIG. 1 reflects the fiber radius and the y-axis reflects the refractive index of the fiber at the operative wavelength of 1550 nm. Fiber profile 10 comprises first core area 20 with radius 25, second core area 30 with a width 35, third core area 40 with a width 45, fourth core area 50 with a width 55, fifth core area 60 with a width 65 and cladding area 70. The combination of first core area 20, second core area 30 and third core area 40 is designated core area 80. First core area 20 has a general shape wherein the refractive index varies over the radius 25 with a peak increased refractive index of 0.0250 for a Δ% of 1.73% and a radius of approximately 1.80 microns. Second core area 30, adjacent to first core area 20, has a general shape exhibiting a depressed index of −0.0070 for a Δ% of −0.48%, with a width 35 of approximately 1.55 microns. Third core area 40, adjacent to second core area 30, exhibits a general shape with an increased refractive index of 0.0250 for a Δ% of 1.73%, which is identical to that of first core area 20. Third core area 40 covers a width of approximately 1.43 microns. Fourth core area 50, adjacent to third core area 40, exhibits a general shape with a depressed refractive index of −0.0060 for a Δ% of −0.42%, which is slightly less than that of second core area 30. Fourth core area 50 covers a width of approximately 2.69 microns. Fifth core area 60, adjacent to fourth core area 50, exhibits a general shape with an increased refractive index of 0.0055 for a Δ% of 0.79%, which is significantly less than that of first core area 20 and third core area 40. Fifth core area 60 covers a width of approximately 2.43 microns. Cladding area 70 adjacent to fifth core area 60 continues to the jacket of the fiber and exhibits the index of refractive of silica glass, which is approximately 1.444 at the operative wavelength of 1550 nm.

An interesting feature of profile 10 is the depressed refractive index ring 30, which has the effect of changing the order in which the modes are supported in the fiber. The combination of first core area 20, second core area 30 and third core area 40, can also be viewed as a single core area 80 with a depressed refractive index ring 30 placed within the core area 80.

Table 1 shows the Delta n_{eff} for each of the modes present in the fiber represented by the profile shown in FIG. 1. Delta n_{eff} is defined throughout this patent as the difference between the n_{eff} of the mode and the refractive index of the cladding material at 1550 nm.

TABLE 1

| | LP₀₁ | LP₁₁ | LP₀₂ | LP₂₁ |
|---|---|---|---|---|
| Delta neff [x10-4] | 85 | 32 | 18 | Not |
| | | | | guided |

Only the LP₀₁, LP₁₁ and LP₀₂ modes are guided, while the LP₂₁ mode is not.

FIG. 2 illustrates the mode intensity of the LP₀₂ mode in the profile 10 of FIG. 1. The x-axis represents the fiber radius and the y-axis reflects the mode intensity in arbitrary units at the operative wavelength of 1550 nm. The mode intensity shows a null energy point 100 at a radial position of approximately 2.45 microns from the center. The secondary lobe 110 peaks at a radial distance of approximately 4.12 microns from the center. It is to be noted that the null energy point 100 occurs within the depressed refractive index ring 30 of profile 10.

FIG. 3 illustrates a plot of the dispersion in the LP₀₂ mode for the few mode fiber profile 10 of FIG. 1, with the x-axis representing wavelength, and the y-axis representing dispersion in ps/nm/km. Curve 120 represents the calculated dispersion in the LP₀₂ mode for fiber profile 10, and exhibits dispersion of −204 ps/km/nm at the operative 1550 nm wavelength, with a PZD of 1476 nm. The profile exhibits a large effective area (A_{eff}) for the LP₀₂ mode of 86 microns², and shows little deviation of dispersion from a straight line over the C band.

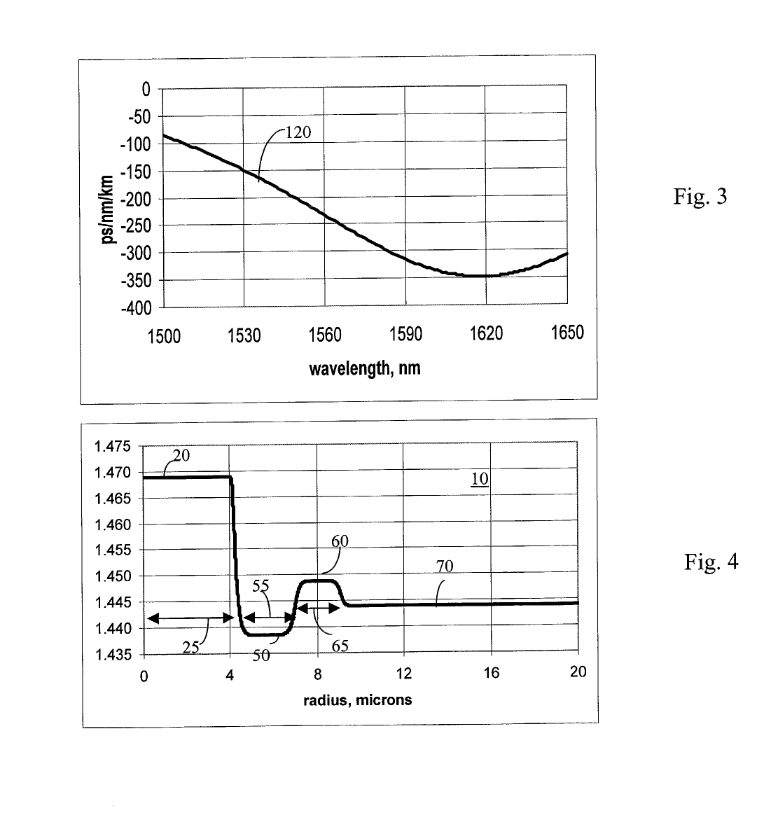

FIG. 4 illustrates a comparison profile which in all respects is similar to the profile of FIG. 1 without the depressed refractive index ring 30. The x-axis reflects the fiber radius and the y-axis reflects the refractive index of the fiber at the operative wavelength of 1550 nm. Fiber profile 10 comprises first core area 20 with radius 25, second core area 50 with a width 55, third core area 60 with a width 65 and cladding area 70. First core area 20, exhibits a general shape with an increased refractive index of 0.0250 for a Δ% of 1.73%, which is identical to that of first core area 20 of the profile of FIG. 1. First core area 20 covers a width of approximately 4.38 microns, which is very similar to the total 4.78 microns of core area 80 of FIG. 1. Second core area 50, adjacent to first core area 20, has a general shape exhibiting a depressed index of −0.0055 for a Δ% of −0.38%, with a width 55 of approximately 2.60 microns. The depressed index of second core area 50 is similar to, but not as deep as the depression of fourth core area 50 of FIG. 1. Third core area 60, adjacent to fourth core area 50, exhibits a general shape with an increased refractive index of 0.0049 for a Δ% of 0.34%, which is significantly less than that of first core area 20. Third core area 60 covers a width of approximately 2.26 microns. In comparison, fifth core area 60 of the profile of FIG. 1 is slightly wider with higher index of refraction. Cladding area 70 adjacent to fifth core area 60 continues to the jacket of the fiber and exhibits the index of refractive of silica glass, which is approximately 1.444 at the operative wavelength of 1550 nm.

A comparison of the profiles of FIG. 1 and that of FIG. 4 show that they are very similar with the exception of the depressed refractive index ring 30, which is absent for the profile of FIG. 4. Other minor modifications made to the profile of FIG. 1 include a slightly greater depression of the refractive index of area 50, and a slightly greater increase in the refractive index of area 60.

Table 2 shows the Delta n_{eff} for each of the modes present in the fiber represented by the profile shown in FIG. 4 at 1550 nm.

TABLE 2

| | LP₀₁ | LP₁₁ | LP₂₁ | LP₀₂ |
|---|---|---|---|---|
| Delta neff [x10-4] | 204 | 135 | 47 | 24 |

Only the LP₀₁, LP₁₁, LP₂₁ and LP₀₂ modes are guided, with the LP₂₁ mode being more strongly guided than the LP₀₂ mode. This is in comparison with the inventive profile 10 of FIG. 1, in which the order of the modes has been modified by the depressed refractive index ring 30 so as to have the LP₂₁ mode be less guided than the LP₀₂ mode.

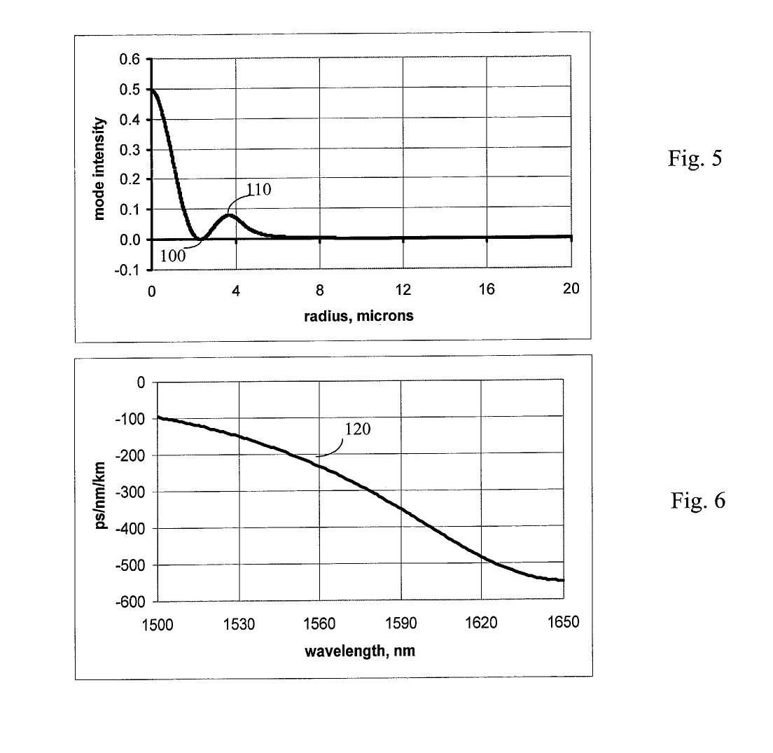

FIG. 5 illustrates the mode intensity of the LP₀₂ mode in the profile 10 of FIG. 4. The x-axis represents the fiber radius and the y-axis reflects the mode intensity in arbitrary units at the operative wavelength of 1550 nm. The mode intensity shows a null energy point 100 at a radial position of approximately 2.30 microns from the center. The secondary lobe 110 peaks at a radial distance of approximately 3.66 microns from the center. It is to be noted that the null energy point 100 occurs within the depressed refractive index ring 30 of profile 10 of FIG. 1.

FIG. 6 illustrates a plot of the dispersion in the LP₀₂ mode for the few mode fiber profile 10 of FIG. 4, with the x-axis representing wavelength, and the y-axis representing dispersion in ps/nm/km. Curve 120 represents the calculated dispersion in the LP₀₂ mode for fiber profile 10, and exhibits dispersion of −202 ps/km/nm at the operative 1550 nm wavelength, with a PZD of 1476 nm. The profile exhibits an effective area (A_{eff}) for the LP₀₂ mode of 51 microns², and shows little deviation of dispersion from a straight line over the C band.

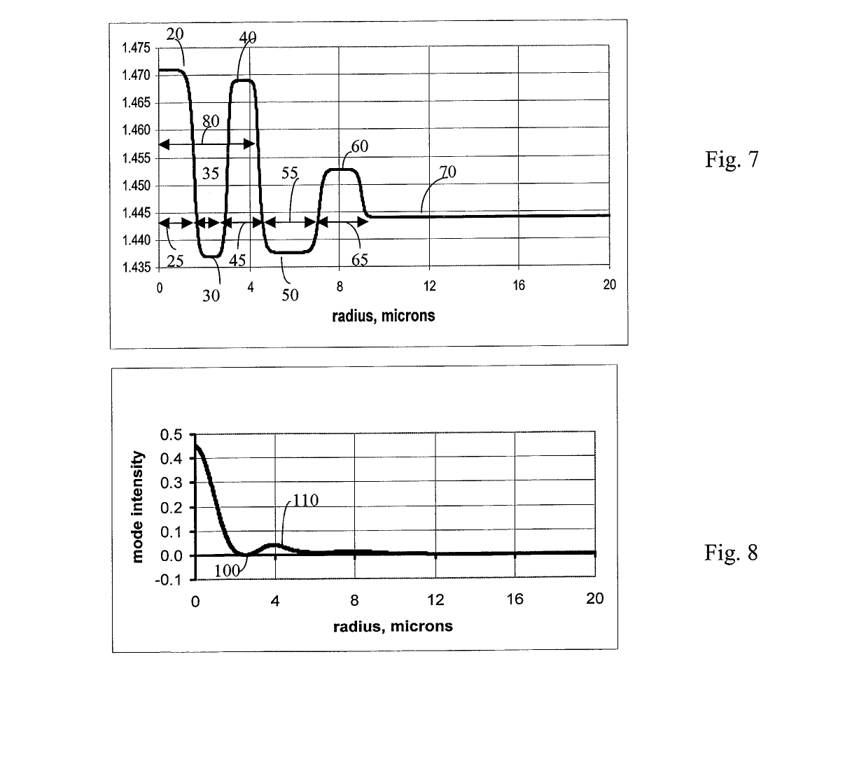

FIG. 7 illustrates a second embodiment of the inventive profile, and represents a modification of the profile 10 FIG. 1 to achieve an increase in negative dispersion and a PZD more in line with that of standard single mode fiber. The x-axis of FIG. 7 reflects the fiber radius and the y-axis reflects the refractive index of the fiber at the operative wavelength of 1550 nm. Fiber profile 10 comprises first core area 20 with radius 25, second core area 30 with a width 35, third core area 40 with a width 45, fourth core area 50 with a width 55, fifth core area 60 with a width 65 and cladding area 70. The combination of first core area 20, second core area 30 and fourth core area 40 is designated core area 80. First core area 20 has a general shape wherein the refractive index varies over the radius 25 with a peak increased refractive index of 0.0270 for a Δ% of 1.87% and a radius of approximately 1.64 microns. Second core area 30, adjacent to first core area 20, has a general shape exhibiting a depressed index of −0.0070 for a Δ% of −0.48%, with a width 35 of approximately 1.29 microns. Third core area 40, adjacent to second core area 30, exhibits a general shape with an increased refractive index of 0.0250 for a Δ% of 1.73%, which is similar to that of first core area 20. Third core area 40 covers a width of approximately 1.62 microns. Fourth core area 50, adjacent to third core area 40, exhibits a general shape with a depressed refractive index of −0.0063 for a Δ% of −0.44%, which is slightly less than that of second core area 30. Fourth core area 50 covers a width of approximately 2.44 microns. Fifth core area 60, adjacent to fourth core area 50, exhibits a general shape with an increased refractive index of 0.0087 for a Δ% of 0.60%, which is significantly less than that of first core area 20 and third core area 40. Fifth core area 60 covers a width of approximately 2.27 microns. Cladding area 70 adjacent to fifth core area 60 continues to the jacket of the fiber and exhibits the index of refractive of silica glass, which is approximately 1.444 at the operative wavelength of 1550 nm.

It is to be noted that the depressed refractive index ring 30 has the effect of changing the order in which the modes are supported in the fiber. The combination of first core area 20, second core area 30 and third core area 40, can also be viewed as a single core area 80 with a depressed refractive index ring 30 placed within the core area 80.

Table 3 shows the Delta n_{eff} for each of the modes present in the fiber represented by the profile shown in FIG. 7 at 1550 nm.

TABLE 3

| | LP₀₁ | LP₁₁ | LP₀₂ | LP₂₁ | LP₀₃ | LP₁₂ |
|---|---|---|---|---|---|---|
| Delta neff [x10-4] | 97 | 49 | 21 | 7 | 3 | 5 |

Only the LP₀₁, LP₁₁and LP₀₂ modes are strongly guided, while the LP₂₁, LP₀₃ and LP₁₂ modes are not. These modes are easily removed with a mode stripper such as a loop of the fiber with radius 4 cm, with the LP₂₁ mode experiencing 2 dB/cm loss, the LP₀₃ mode experiencing 219 dB/cm loss and the LP₁₂ mode experiencing 31 dB/cm loss. All other guided modes experience substantially less than 1 dB/cm loss for such a loop, typically less than 10 ⁻⁶ dB/cm. It is to be noted that the LP₀₂ mode is more strongly guided than the LP₂₁ mode.

FIG. 8 illustrates the mode intensity of the LP₀₂ mode in the profile 10 of FIG. 7. The x-axis represents the fiber radius and the y-axis reflects the mode intensity in arbitrary units at the operative wavelength of 1550 nm. The mode intensity shows a null energy point 100 at a radial position of approximately 2.47 microns from the center. The secondary lobe 110 peaks at a radial distance of approximately 3.89 microns from the center. It is to be noted that the null energy point 100 occurs within the depressed refractive index ring 30 of profile 10 of FIG. 7.

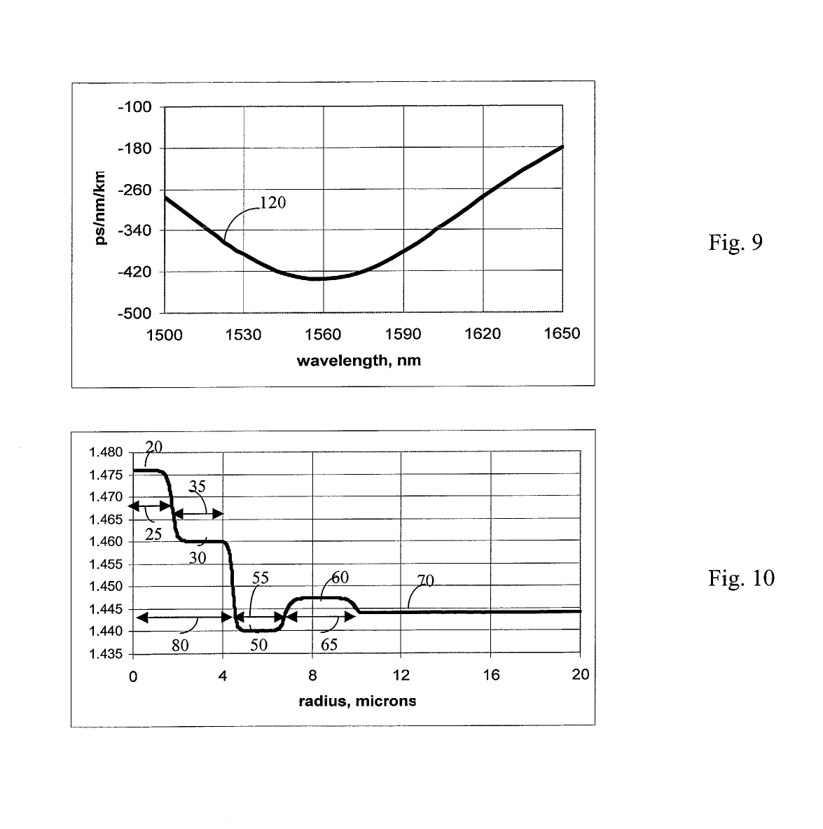

FIG. 9 illustrates a plot of the dispersion in the LP₀₂ mode for the few mode fiber profile 10 of FIG. 7, with the x-axis representing wavelength, and the y-axis representing dispersion in ps/nm/km. Curve 120 represents the calculated dispersion in the LP₀₂ mode for fiber profile 10, and exhibits dispersion of approximately −430 ps/km/nm at the operative 1550 nm wavelength, with a PZD of about 1282 nm. Such a PZD is suitable for use to compensate a span of standard single mode fiber. The profile exhibits an effective area (A_{eff}) for the LP₀₂ mode of 77 microns², however it exhibits some additional deviation of dispersion from a straight line over the C band.

FIG. 10 illustrates a third embodiment of the inventive profile without the depressed refractive index ring 30 of FIG. 1 and FIG. 7, and instead utilizes a reduction in the refractive index, while maintaining an increased refractive index in relation to the cladding, to accomplish similar results. The x-axis of FIG. 10 reflects the fiber radius and the y-axis reflects the refractive index of the fiber at the operative wavelength of 1550 nm. Fiber profile 10 comprises first core area 20 with radius 25, second core area 30 with a width 35, third core area 50 with a width 55, fourth core area 60 with a width 65 and cladding area 70. The combination of first core area 20, and second core area 30 is designated core area 80. First core area 20 has a general shape wherein the refractive index varies over the radius 25 with a peak increased refractive index of 0.0320 for a Δ% of 2.22% and a radius of approximately 2.03 microns. Second core area 30, adjacent to first core area 20, has a general shape exhibiting a reduced refractive index of 0.0161 for a Δ% of 1.11%, with a width 35 of approximately 2.55 microns. Third core area 50, adjacent to second core area 30, exhibits a general shape with a depressed refractive index of −0.0039 for a Δ% of −0.27%. Third core area 50 covers a width of approximately 2.28 microns. Fourth core area 60, adjacent to third core area 50, exhibits a general shape with an increased refractive index of 0.0034 for a Δ% of 0.24%, which is significantly less than that of first core area 20 and second core area 30. Fourth core area 60 covers a width of approximately 3.18 microns. Cladding area 70 adjacent to fourth core area 60 continues to the jacket of the fiber and exhibits the index of refractive of silica glass, which is approximately 1.444 at the operative wavelength of 1550 nm.

It is to be noted that the change in refractive index from first core area 20 to second core area 30, has the effect of changing the order in which the modes are supported in the fiber. The combination of first core area 20 and second core area 30 can be viewed as a single core area 80 with two zones.

Table 4 shows the Delta n_{eff} for each of the modes present in the fiber represented by the profile shown in FIG. 10 at 1550 nm.

TABLE 4

| | LP₀₁ | LP₁₁ | LP₀₂ | LP₂₁ |
|---|---|---|---|---|
| Delta neff [x10-4] | 195 | 81 | 19 | Not |
| | | | | guided |

Only the LP₀₁, LP₁₁ and LP₀₂ modes are guided, while the LP₂₁ mode is not guided.

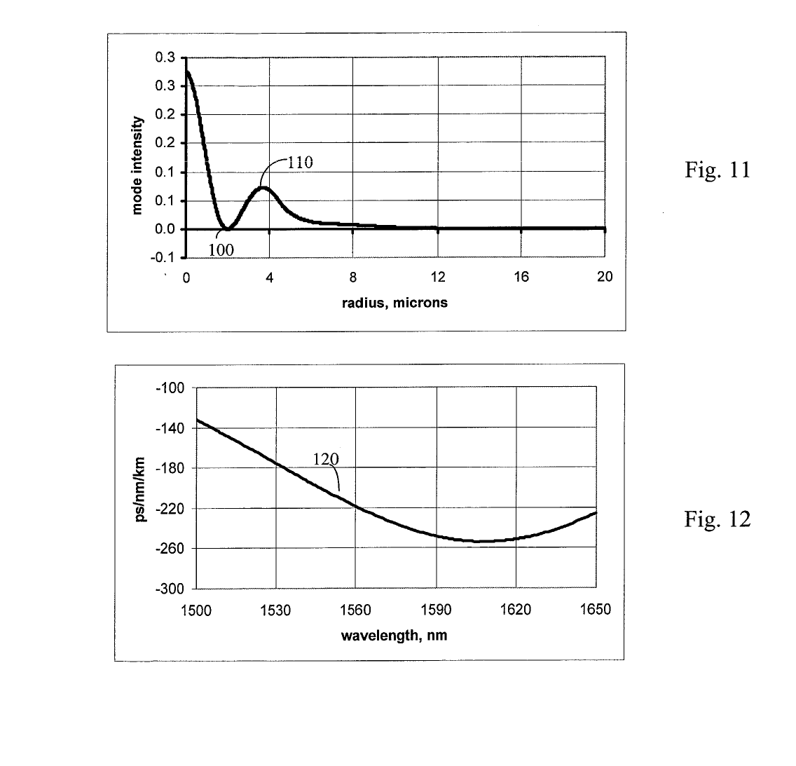

FIG. 11 illustrates the mode intensity of the LP₀₂ mode in the profile 10 of FIG. 10. The x-axis represents the fiber radius and the y-axis reflects the mode intensity in arbitrary units at the operative wavelength of 1550 nm. The mode intensity shows a null energy point 100 at a radial position of approximately 2.00 microns from the center. The secondary lobe 110 peaks at a radial distance of approximately 3.66 microns from the center. It is to be noted that the null energy point 100 occurs substantially at the point of transition between first core area 20 and second core area 30 of profile 10 of FIG. 10.

FIG. 12 illustrates a plot of the dispersion in the LP₀₂ mode for the few mode fiber profile 10 of FIG. 7, with the x-axis representing wavelength, and the y-axis representing dispersion in ps/nm/km. Curve 120 represents the calculated dispersion in the LP₀₂ mode for fiber profile 10, and exhibits dispersion of −205 ps/km/nm at the operative 1550 nm wavelength, with a PZD of 1406 nm. Such a PZD is suitable for use to compensate a span of non-zero dispersion shifted fiber. The profile exhibits a large A_{eff} for the LP₀₂ mode of 117 microns² and very little deviation from a straight line over the C band.

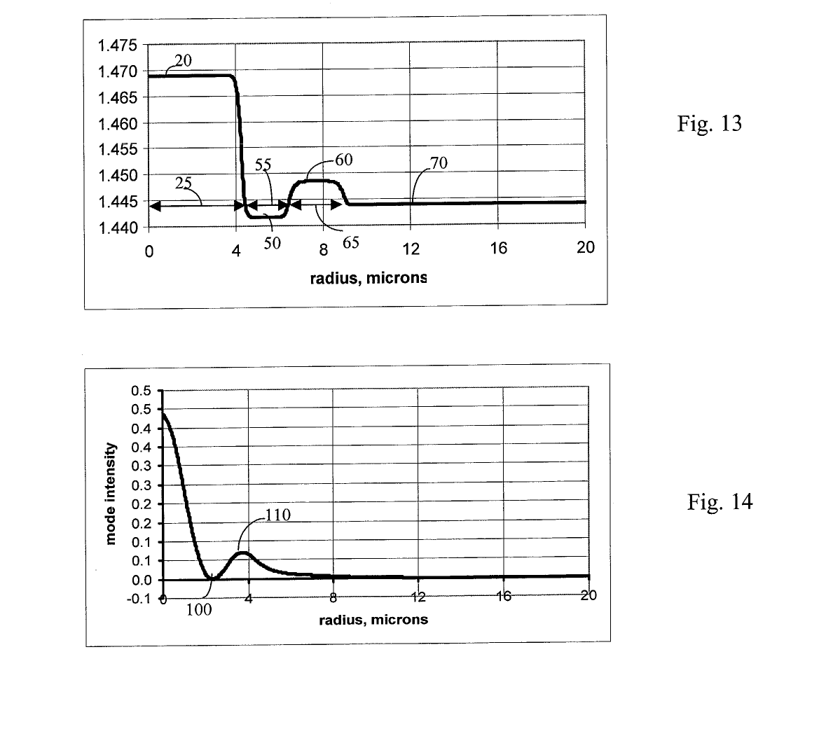

FIG. 13 illustrates a comparison profile which in all respects is similar to the profile of FIG. 10 without the reduced refractive index area 30. The x-axis reflects the fiber radius and the y-axis reflects the refractive index of the fiber at the operative wavelength of 1550 nm. Fiber profile 10 comprises first core area 20 with radius 25, second core area 50 with a width 55, third core area 60 with a width 65 and cladding area 70. First core area 20, exhibits a general shape with an increased refractive index of 0.0250 for a Δ% of 1.73%, which is less than that of first core area 20 of the profile 10 of FIG. 10, but greater than that of second core area 30. First core area 20 covers a width of approximately 4.40 microns, which is very similar to the total 4.58 microns of core area 80 of FIG. 1. Second core area 50, adjacent to first core area 20, has a general shape exhibiting a depressed index of −0.0024 for a Δ% of −0.17%, with a width 55 of approximately 2.04 microns. In comparison, second core area 50 of FIG. 13 is shallower and not as wide as third core area 50 of FIG. 10. Third core area 60, adjacent to second core area 50, exhibits a general shape with an increased refractive index of 0.0045 for a Δ% of 0.31%, which is significantly less than that of first core area 20. Third core area 60 covers a width of approximately 2.62 microns. In comparison, fourth core area 60 of the profile of FIG. 10 is slightly wider with a shallower index of refraction. Cladding area 70 adjacent to third core area 60 continues to the jacket of the fiber and exhibits the index of refractive of silica glass, which is approximately 1.444 at the operative wavelength of 1550 nm.

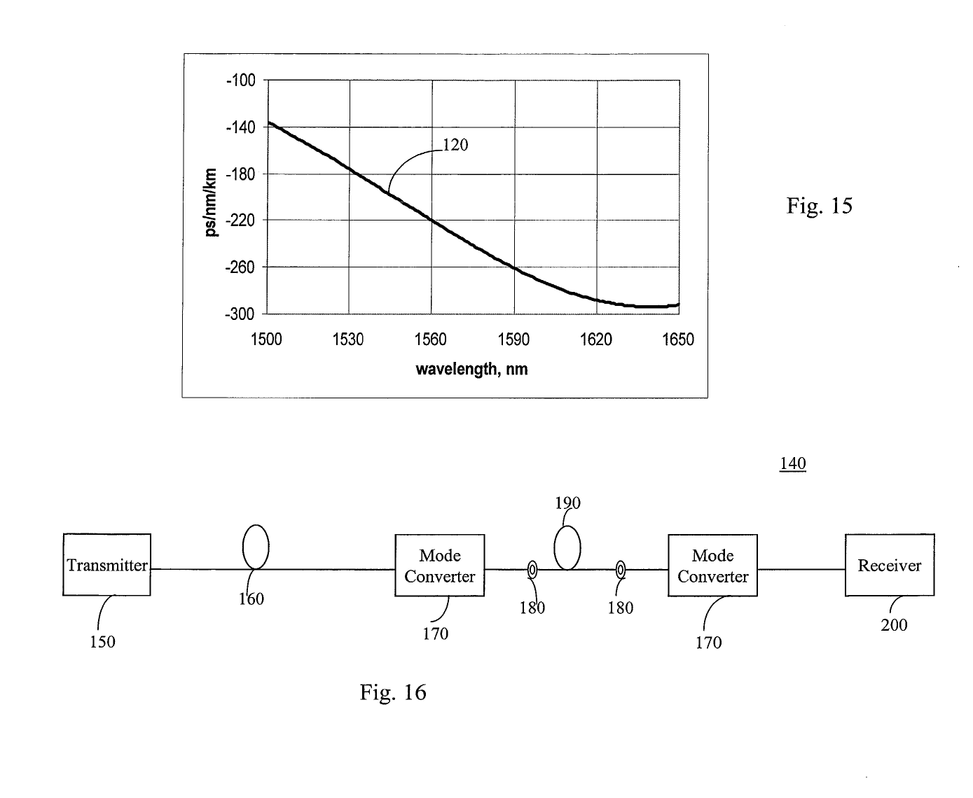

A comparison of the profiles of FIG. 13 and that of FIG. 10 show that they are very similar with the exception of the step to a reduced refractive index area 30, which is absent for the profile of FIG. 13. As will be seen further in relation to FIG. 14 and FIG. 15, other minor modification have been made so that the profile 10 of FIG. 13 exhibits very similar results to that of FIG. 10 with the exception of the number and order of mode. Table 5 shows the Delta n_{eff} for each of the modes present in the fiber represented by the profile shown in FIG. 13 at 1550 nm.

TABLE 5

| | LP₀₁ | LP₁₁ | LP₂₁ | LP₀₂ |
|---|---|---|---|---|
| Delta neff [x10-4] | 204 | 136 | 50 | 30 |

Only the LP₀₁, LP₁₁, LP₂₁ and LP₀₂ modes are guided, with the LP₂₁ mode being more strongly guided than the LP₀₂ mode. This is in comparison with the inventive profile 10 of FIG. 10, in which the order of the modes has been modified by the reduction in refractive step from core area 20 to core area 30 so as to have the LP₂₁ mode be less guided than the LP₀₂ mode.

FIG. 14 illustrates the mode intensity of the LP₀₂ mode in the profile 10 of FIG. 13. The x-axis represents the fiber radius and the y-axis reflects the mode intensity in arbitrary units at the operative wavelength of 1550 nm. The mode intensity shows a null energy point 100 at a radial position of approximately 2.34 microns from the center. The secondary lobe 110 peaks at a radial distance of approximately 3.76 microns from the center.

FIG. 15 illustrates a plot of the dispersion in the LP₀₂ mode for the few mode fiber profile 10 of FIG. 13, with the x-axis representing wavelength, and the y-axis representing dispersion in ps/nm/km. Curve 120 represents the calculated dispersion in the LP₀₂ mode for fiber profile 10, and exhibits dispersion of −206 ps/km/nm at the operative 1550 nm wavelength, with a PZD of 1408 nm. The profile exhibits an effective area (A_{eff}) for the LP₀₂ mode of 63 microns², and shows little deviation of the dispersion from a straight line over the C band.

FIG. 16 illustrates a high level block diagram of a system utilizing the subject inventive fiber design and will be described in connection with a fiber according to profile 10 of FIG. 7. This is not meant to be limiting in any way, and is equally adaptable by one skilled in the art to any profile using the teaching of this invention. The system 140 of FIG. 16 comprises transmitter 150, single mode fiber 160, mode transformer 170, mode stripper 180, high order mode fiber 190, and receiver 200. The output of transmitter 150 is connected to one end of a span of single mode fiber 160, and the second end of single mode fiber 160 is connected to the input of first mode transformer 170. The output of mode transformer 170 is connected to the input of first mode stripper 180, and the output of first mode stripper 180 is connected to one end of high order mode fiber 190. The other end of high order mode fiber 190 is connected to the input of second mode stripper 180, and the output of second mode stripper 180 is connected to the input of second mode transformer 170. The output of second mode transformer 170 is connected to receiver 200.

In the operation of system 140, transmitter 150 operates to produce an optical signal which is injected into one end of single mode fiber 160. A single span of single mode fiber 160 is shown for clarity, however multiple spans utilizing optical amplification between spans may also be utilized without exceeding the scope of this application. The optical signal exits the second end of fiber 160 with dispersion caused by traversing the length of fiber. The optical signal propagates into first mode transformer 170, which operates to convert substantially all of the signal from the fundamental mode to a single high order mode. In one embodiment the single high order mode is the LP₀₂ mode. Mode transformers are well known to those skilled in the art. In an exemplary embodiment mode transformer 170 comprises a transverse mode transformer of the type described in copending U.S. patent application Ser. No. 09/248,969 filed Feb. 12, 1999 entitled “Transverse Spatial Mode Transformer for Optical Communication” whose contents are incorporated herewith by reference.

The output of first mode transformer 170 propagates into high order mode fiber 190 through mode stripper 180. Mode stripper 180 comprises at least one loop of high order mode fiber 190, whose radius is chosen so as to cause significant loss to some of the undesired modes. Undesired modes exist in the fiber as a result of the design, which allows for some high order modes which experience large bending losses, imperfect mode transformation, inherent defects in the fiber and other inaccuracies. In an exemplary embodiment mode stripper 180 comprises a single loop of high order mode fiber 190 with a radius of 4 cm. Referring to Table 3, placing a loop of 4 cm in the fiber, the undesired LP₂₁, LP₀₃ and LP₁₂ modes can effectively be eliminated by the loop. The signal in the desired LP₀₂ mode experiences minimal loss, and is thus not affected.

The signal enters the balance of high order mode fiber 190 substantially completely in the LP₀₂ mode. The effective difference in n_{eff} between the LP₀₂ mode and the other two supported modes is substantial and thus little mode coupling is experienced. The optical signal experiences negative dispersion and slope according to the characteristics of the fiber effectively compensating for the dispersion experienced by the signal as it propagated through single mode fiber 160. The second end of high order mode fiber 190 is again formed into a second mode stripper 180, by forming a loop of the fiber 190 whose radius is pre-selected so as to cause significant loss to any undesired modes. Undesired modes caused by coupling in the fiber 190 can thus be effectively eliminated. In an exemplary embodiment second mode stripper 180 comprises a loop of radius 4 cm, thus effectively eliminated any optical energy in the LP₂₁, LP₀₃ and LP₁₂ modes. The remaining optical energy, substantially completely in the LP₀₂ mode is coupled to the input of second mode transformer 170, which acts to convert the optical energy to the fundamental, or LP₀₁ mode. The output of second mode transformer 170 is connected to receiver 150. In another embodiment (not shown) the output of mode transformer 200 is connected to an optical amplifier, whose output is connected to an additional span of transmission fiber 160.

In an alternative embodiment additional mode strippers are added at pre-determined distances along the length of the fiber. These mode strippers are added so as to prevent the occurrence of second order coupling in which the desired mode first couples to an undesired mode, and then some of that energy is recoupled back to the original mode. The recoupled energy traveled at a different rate while in the undesired mode, and therefore the recoupled energy is out of phase with the desired signal. This out of phase condition contributes to MPI.

The invention has been described in connection with a dispersion compensating fiber, with the desired mode being the LP₀₂ mode. It is to be understood that this is not meant to be limiting in any way and other mode combinations may be used in connection with the invention. The high order mode fiber may also be designed as a transmission fiber having special characteristics, such as that described in copending U.S. patent application Ser. No. 09/510,027 filed Feb. 22, 2000, entitled “High Order Spatial Mode Optical Fiber” whose contents are incorporated by reference.

The invention has also been described in connection with a depressed refractive index ring or as an alternative embodiment a reduction in the refractive index. This is not meant to be limiting in any way, and is specifically intended to include an increased area of refractive index as described in copending U.S. patent application Ser. No. 09/481,428 filed Jan. 12, 2000 entitled “Reducing Mode Interference in Transmission of a High Order Mode in Optical Fibers” whose contents are incorporated by reference.

Having described the invention with regard to certain specific embodiments thereof, it is to be understood that the description is not meant as a limitation, since further modifications may now suggest themselves to those skilled in the art, and it is intended to cover such modifications as fall within the scope of the appended claims.

We claim:

1. A few mode optical waveguide having a refractive index profile preselected to support at least three modes, said refractive index profile comprising a refractive index ring placed at a location where one of the supported modes has substantially zero energy, whereby only three modes exhibit a loss less than 1 db/cm in a loop with a radius of no more than 4 cm.

2. A few mode optical waveguide according to claim 1 wherein said one of the supported modes comprises the LP₀₂ mode.

3. A few mode optical waveguide according to claim 1 wherein one of said only three modes comprises the LP₁₁ mode.

4. A few mode optical waveguide according to claim 1 wherein said desired modes exhibit a loss less than 10⁻⁶ db/cm in a loop with a radius of no more than 4 cm.

5. A few mode optical waveguide according to claim 1 wherein said refractive index ring comprises a depressed refractive index in the core area.

6. A few mode optical waveguide according to claim 1 wherein said refractive index ring comprises an increased refractive index in the core area.

7. A few mode optical waveguide according to 1 wherein said refractive index profile comprises a first core region of increased refractive index, an adjacent second core region of depressed refractive index being said refractive index ring, an adjacent third core region of increased refractive index, an adjacent fourth core region of depressed refractive index and an adjacent fifth core region of increased refractive index.

8. A few mode optical waveguide according to claim 1, wherein said waveguide exhibits negative dispersion for an optical signal in one of said only three modes.

9. A few mode optical waveguide according to claim 8, wherein said one of said only three modes comprises the LP₀₂ mode.

10. A few mode optical waveguide according to claim 8, wherein said waveguide exhibits negative dispersion slope for an optical signal in the LP₀₂ mode.

11. A few mode optical waveguide having a refractive index profile preselected to support no more than three modes at an operating wavelength, said refractive index comprising a refractive index step placed substantially at a location where one of said three modes has substantially zero energy.

12. A few mode optical waveguide according to claim 11 wherein said one of said modes comprises the LP₀₂ mode.

13. A few mode optical waveguide according to claim 11 wherein one of said three modes comprises the LP₁₁ mode.

14. A few mode optical waveguide according to claim 11 wherein said refractive index step comprises a reduction in the refractive index in the core area.

15. A few mode optical waveguide according to claim 11 wherein said refractive index ring comprises an increase in the refractive index in the core area.

16. A few mode optical waveguide according to 11 wherein said refractive index comprises a first core region of increased refractive index, an adjacent second core region of lower increased refractive index, an adjacent third core region of depressed refractive index and an adjacent fourth core region of increased refractive index.

17. A few mode optical waveguide according to claim 11, wherein said waveguide exhibits negative dispersion for an optical signal in one of said three modes.

18. A few mode optical waveguide according to claim 17, wherein said one mode is the LP₀₂ mode.

19. A few mode optical waveguide according to claim 11, wherein said waveguide exhibits negative dispersion slope for an optical signal in the LP₀₂ mode.

20. A few mode optical waveguide designed to have specific characteristics in a desired high order mode comprising:
a refractive index profile preselected to support at least three modes;
said refractive index profile comprising a refractive index ring placed at a location where the desired mode has substantially zero energy,
whereby only two modes other than said desired mode exhibit a loss less than 1 db/cm in a loop with a radius of no more than 4 cm.

21. A few mode optical waveguide according to claim 21 wherein said desired mode comprises the LP₀₂ mode.

22. A method of designing a few mode fiber profile having no more than three modes, said modes being the desired modes, said fiber profile being further characterized by having a desired dispersion and dispersion slope for a signal in one of the desired modes, comprising the steps of:
designing a base profile having similar dispersion and dispersion slope characteristics to the desired characteristics, said base profile supporting more than three modes;
adding a refractive index ring or refractive index step to said base profile thereby creating an intermediate profile, said ring or step being located such that the energy of one of the desired modes is substantially zero in said refractive index ring or said refractive index step, such that only the desired modes are substantially supported in said intermediate profile, and
modifying said intermediate profile to optimize the few mode fiber profile to achieve the desired dispersion and dispersion slope characteristics, while supporting only said desired modes.
